(19) United States
(12) Patent Application Publication
(10) Pub. No.: US 2010/0330522 A1
(43) Pub. Date: Dec. 30, 2010

(54) ORTHODONTIC OR DENTAL ELEMENTS

(75) Inventor: Markus Johannes Hirsch, Klagenfurt (AT)

Correspondence Address: COLLARD & ROE, P.C., 1077 NORTHERN BOULEVARD, ROSLYN, NY, 11576, US

(73) Assignee: PBD, Patent & Business Development AG, Zug (CH)

(21) Appl. No.: 12/735,577

(22) PCT Filed: Jan. 30, 2009
(86) PCT No.: PCT/AT2009/000034

§ 371 Date: Aug. 20, 2010

(30) Foreign Application Priority Data
Jan. 30, 2008 (AT) A 140/2008

(51) Int. Cl. A61C 7/18; A61C 7/00; A61C 19/00; A61C 7/14; A61C 7/20; A61C 13/003; A61C 5/08; A61C 13/007; A61C 13/08; B05D 3/00; C09K 3/00

(52) U.S. Cl. 433/8; 433/2; 433/215; 433/23; 433/17; 433/167; 433/218; 427/2.29; 106/35

(57) ABSTRACT

The invention relates to orthodontic or dental appliances with a substrate, at least certain regions of which are provided with a coating containing titanium dioxide and/or titanium nitride, as well as a coating formulation and a method of applying the coating formulation to the orthodontic or dental appliances.

The invention relates to an orthodontic and/or dental appliance with a substrate, at least certain regions of which are coated, an orthodontic system comprising a bracket with a cut-out for receiving an archwire and an archwire, a method of coating at least certain regions of orthodontic and/or dental appliances comprising several steps and use of the orthodontic and/or dental appliance.

Conservative methods are available these days as a means of correcting misaligned teeth or jaw anomalies, in addition to surgical intervention. Such orthodontic treatments may be used to position or re-align individual teeth on the one hand, but can also be employed as a means of improving a person's visual appearance, for example in situations where the misalignment affects front regions of the jaw. In more serious cases, a misalignment can also lead to incorrect closing of the mouth and thus make chewing movements more difficult.

One conservative method of treating misaligned teeth is to use dental braces, which can be removed as a whole by the wearer and are worn overnight only, for example. In recent years, however, there has been a growing trend towards the used of fixed correction devices, which are fitted directly on the wearer's teeth. To this end, brackets are attached to the front face of the patient's teeth and the brackets of adjacent teeth are connected to one another by means of an archwire. The brackets are successively moved along this archwire and because the bracket are attached to the teeth, the teeth are also moved as well and are moved into the desired position.

Orthodontic brackets may be made from a range of different materials such as metals (stainless steel), plastics (polycarbonate) and ceramic materials such as monocrystalline and polycrystalline aluminium. The advantage of the latter is that brackets made from such materials tare transparent and see-through. The disadvantage of ceramic materials is that they exhibit abrasion in the region where they are connected to the archwire, as a result of which the hard ceramic material of the bracket causes notches in the soft material of the archwire. These notches are not conducive to the movement of the bracket along the archwire. The occurrence of abrasion slows down the movement of the teeth, thereby resulting in longer treatment.

Orthodontic articles with coatings of silicon nitrite or zirconium oxide are known from the prior art. They are described as reducing abrasion of the archwire.

In view of the above, the objective of this invention is to propose an alternative coating for an orthodontic article, whereby abrasion is reduced whilst simultaneously producing an aesthetic effect and frictional forces are kept to a low level.

The objective of this invention is achieved, independently in each case, by an orthodontic and/or dental appliance or an orthodontic system, in which the coating contains titanium dioxide and/or titanium nitride and silver or at least one silver compound. The objective is also achieved, likewise independently, by a method of coating at least certain regions of orthodontic and/or dental appliances with a substrate whereby the coating is applied to at least certain regions of the substrate in a container with a spray mechanism and involves the steps of (i) spraying the orthodontic and/or dental appliances at least once with a coating formulation as they are moved in the container and (ii) drying and hardening the surface of the sprayed orthodontic and/or dental appliances.

In this respect, it has proved to be of advantage to use titanium dioxide and/or titanium nitride because they enable a chemically, mechanically and thermally very stable coating to be produced. What has also proved to be of advantage is the fact that titanium dioxide is insoluble in water, organic solvents and diluted acids and bases. Due to its insolubility, it can not in practical terms be absorbed in the digestive tract or migrate into the tissue.

Using titanium dioxide in the coating has also proved to be of advantage because it enables a transparent or white coloured coating to be obtained so that the orthodontic appliance can be fitted in the region of the teeth so that it is inconspicuous because the colour of the orthodontic appliance is no different or barely differs from the colour of the teeth.

Applying the coating with silver ions, for example in the form of silver or silver compounds, is of advantage because it enables an antimicrobial effect to be obtained. As a result of these anti-microbial properties of the coating, the reproduction of micro-organisms, in particular bacteria, can be prevented, especially at points of the bracket that are not easily accessible or at points where the archwire is joined to the bracket or the bracket is attached to the tooth surface.

As a result of the method of coating at least certain regions of orthodontic and/or dental appliances with a substrate, whereby the coating is applied to at least certain regions of the substrate in a container with a spray mechanism, comprising the steps of (i) spraying the orthodontic and/or dental appliances moved in the container at least once with a coating formulation and (ii) drying and hardening the surface of the orthodontic and/or dental appliances, a particularly uniform coating is obtained, which is of enormous importance in the case of such small appliances, because even the slightest variances in dimensions make orthodontic or dental treatment more difficult.

Titanium dioxide or titanium nitride is contained in the coating in a quantity selected from a range with a lower limit of 20% and an upper limit of 95%, thereby enabling a chemically as well as mechanically and thermally very stable coating to be produced, whilst simultaneously satisfying very high demands with regard to aesthetics.

It has also proved to be of advantage that titanium dioxide is present in the rutile modification, which represents the most stable form of titanium dioxide, which means that the very high quality requirements placed on the coating can be met.

The quantity of silver or the at least one silver compound is selected from a range with a lower limit of 0.5% and an upper limit of 25%, thereby imparting anti-microbial properties to the coating. The bacteria which occur in the oral cavity are therefore killed.

In another embodiment of the invention, the coating contains both titanium dioxide and/or titanium nitride and silver or at least one silver compound, as a result of which the positive properties obtained due to the individual components can be combined with one another, namely the fact that the coating is very hard and has a high resistance on the one hand and the fact that microbial properties are obtained on the other hand. This results in a combination effect insofar as longer durability for a longer period means that points that are naturally difficult to access can not be cleaned, thereby increasing the risk of caries. The anti-microbial properties mean that the bacteria which cause caries can also be eliminated from areas which are difficult to access.

The at least one silver compound may be selected from a group comprising silver chloride, silver acetate, silver carbonate or mixtures thereof, thereby achieving a very high degree of effectiveness in combating micro-organisms.

In another embodiment, the coating may contain silicon dioxide, thereby imparting valuable physical and chemical properties and ensuring that such coatings also adhere extremely well to different substrates.

The coating may also contain dye particles, thereby imparting colour to the coating and hence also to the bracket and archwire.

The coating may be both hydrophobic and oleophobic, thereby preventing dirt from being deposited, which would otherwise lead to discoloration and cause an unaesthetic appearance.

The coating also has a thickness selected from a range with a lower limit of 100 nm and an upper limit of 100 μm, which produces a sufficient thickness to cope with high stress on the one hand but is thin enough to avoid any negative influence of the geometric shape of such small appliances on the other hand.

The substrate is preferably of metal such as stainless steel, plastic such as polycarbonate, or ceramic material such as monocrystalline or polycrystalline aluminium oxide, thereby enabling orthodontic or dental appliances with a very high hardness level to be produced.

The coating is preferably bonded to the substrate by a covalent bond, thereby preventing abrasion of the bracket, especially in the case of softer composite materials.

The temperature during the coating process and when drying and hardening the applied coating formulation is selected from a range with a lower limit of 20° C. and an upper limit of 250° C., as a result of which the surface of the orthodontic and/or dental appliances has an extremely high hardness. The temperature during drying is preferably 180° C.

The coating is applied with a coating formulation containing at least one solvent selected from a group comprising ethanol, propanol, butanol, optionally a silicon compound selected from a group comprising glycidyloxypropyltrimethoxy silane, etc., titanium dioxide and/or titanium nitride as well as silver or at least one silver compound, thereby enabling a coating with very good mechanical and chemical surface properties and anti-microbial properties to be obtained.

Firstly, it should be pointed out that the positions chosen for the purposes of the description, such as top, bottom, side, etc., relate to the drawing specifically being described and can be transposed in terms of meaning to a new position when another position is being described. Individual features or combinations of features from the different embodiments illustrated and described may be construed as independent inventive solutions or solutions proposed by the invention in their own right.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

Orthodontic and/or dental appliance may be used in jaw orthopedics in the form of brackets, archwires, bands, buccal tubes, implants, pins, braces, tooth clips, etc. and in dental technology as tooth replacements, prostheses, crowns, anchors, bridges.

An example of an orthodontic appliance or system with a coating as proposed by the invention will be described below by way of illustration. As explained above, the coating proposed by the invention may also be used for other orthodontic and/or dental appliances, in which case the same or similar effects can be obtained. A brace comprises a plurality of brackets with an archwire. Each bracket is attached to an individual tooth and the archwire extends across several brackets and interacts with every individual bracket. Braces may be fitted both in the region of the upper jaw and in the region of the lower jaw. The archwire acts as a guide for the movement of the brackets into the desired position and hence also the teeth throughout the duration of treatment. One or more or all of the brackets and the archwire contain the coating proposed by the invention to assist the sliding mechanism during the orthodontic treatment. In particular, the coating proposed by the invention reduces abrasion and frictional resistance between the bracket and archwire. During treatment, the jaw orthopaedist, dentist or dental technician will adjust the archwire so that the brackets and co-operating teeth move along the archwire and are subjected to the influence of the forces caused by the dentist or dental technician. The reduced abrasion and friction—achieved as a result of the coating proposed by the invention—enable the bracket to be moved more easily along the archwire, thereby enabling the treatment time for the orthodontic treatment to be shortened.

A bracket itself consists of a base plate and wings. The base plate is connected to the tooth surface. The wings are connected to the base plate, leaving a gap or cut-out free for accommodating the archwire. Naturally, other designs of bracket would also be possible. The cutout is that part of the bracket which interacts with the archwire. The coating proposed by the invention is applied to at least this region in order to reduce friction between the bracket and archwire. Projections on the wings are used as a means of interacting with elastomers or wire connections known from the prior art. Special designs of a bracket are described in the application filed by this applicant on the same date, for example.

The bracket may be made from various substrates. Materials which may be used for the substrate are metal materials such as stainless steel, plastic materials such as polycarbonate, and ceramic materials such as monocrystalline and polycrystalline aluminium oxide. It would naturally also be possible to use alloys or composite materials. The bracket may be made or moulded from a substrate using methods known from the prior art. The coating proposed by the invention may naturally also be applied to commercially available brackets.

The coating may be applied in a single layer or in several layers and may be applied to only parts of the surface of the orthodontic appliance or to the full surface. For example, the coating may be applied in the cut-out of the bracket in order to keep the coefficient of friction between the bracket and archwire low.

In another embodiment, the coating proposed by the invention may naturally also be applied to other regions of orthodontic appliances. The coating may be applied to the entire surface of the substrates of the orthodontic appliance with the exception of the bottom face of the bracket, which is used to connect the bracket to the der tooth surface. In an alternative embodiment, a coating may also be applied to the bottom face of the bracket.

The coating composition contains titanium dioxide and/or titanium nitride, which corresponds to a very high mechanical and chemical resistance and satisfies high aesthetic demands. Applying the coating means that there is no direct contact between the archwire and the substrate of the bracket, thereby preventing the harder material of the bracket from causing notches in the softer material of the archwire.

The quantity of titanium dioxide and titanium nitride in the orthodontic appliance is selected from a range with a lower limit of 20% and an upper limit of 95%. It has proved to be of particular advantage to opt for a proportion of the titanium compounds in the range of from 60 to 90% and in particular in the range of from 70% to 80%.

Titanium dioxide and titanium nitride are added to the coating formulation in the form of very small particles in the nanometre range or are created in the coating formulation in the aforementioned size.

In order to meet the high demands of mechanical resistance, titanium dioxide is used in the rutile modification for the coating.

In order to obtain the added effect of creating anti-microbial properties, the orthodontic or dental appliance contains silver ions in its coating in the form of silver or silver compounds. The proportion of silver or silver compounds in the coating of the orthodontic appliance is selected from a range with a lower limit of 0.5% and an upper limit of 25% and a proportion of 1% to 10%, in particular 3% to 7%, has proved to be of particular advantage.

In one particularly preferred embodiment, the coating of the orthodontic or dental appliance contains both titanium dioxide and silver or a silver compound, thereby resulting in a coating for the orthodontic and/or dental appliance with high mechanical resistance in combination with anti-microbial properties. Silver chloride is preferably used as the silver compound. In a preferred embodiment, titanium dioxide and silver chloride are used in the quantities specified above.

In another embodiment, it is also possible to add a proportion of silicon compounds such as silicon dioxide to the coating of the orthodontic and/or dental appliance.

In order to impart colour to the coating, dye particles may be added to it, in which case yellow pigments may be admixed with it, for example, thereby enabling the bracket, archwire, replacement tooth, crown and such like to be adapted to match the natural colour of the teeth.

To prevent the orthodontic and/or, dental appliances from becoming dirty, the coating also has hydrophobic and oleophobic properties.

The coating is applied to the orthodontic and/or dental appliances as a very thin film. Examples of the thickness of the coating are selected from a range with a lower limit of 100 nm and an upper limit of 100 μm, and a thickness of from 1 μm to 20 μm has proved to be of particular advantage.

The substrate of the archwire contains metal materials such as stainless steel, β-titanium, nickel-titanium alloy with shape memory properties, plastics, etc. The archwire may have a cross-section of different geometric shapes and the cross-section may be round, square, rectangular, etc . . .

The coating proposed by the invention is preferably applied to the entire surface of the substrate of the archwire. Both the composition and thickness of the coating of the archwire are the same as the coating and thickness of the coating of the bracket.

Due to the fine thickness of the coating proposed by the invention, it can be applied to all commercially available orthodontic and/or dental appliances, such as brackets, archwires, replacement teeth, crowns, implants, bridges, etc., without having to make constructive modifications to these appliances.

When using the orthodontic system, it is possible to apply the coating to only certain regions where one orthodontic appliance (bracket) interacts with another orthodontic appliance (archwire). For example, the coating can be applied solely in the cut-out of the bracket which accommodates the archwire. In an alternative embodiment, the archwire exclusively is coated. In another alternative embodiment, both the cut-outs of the bracket and the actual archwire can be coated. It would naturally also be possible to coat the entire surface of the bracket or areas that are bigger than just the cut-out of the bracket. The areas to which the coating can be applied are not restricted to the areas specifically mentioned above in the description and explanation.

The coating proposed by the invention may be applied by spraying, dipping or any other coating methods known from the prior art.

In a preferred embodiment, the coating is applied by the method proposed by the invention. Before orthodontic and/or dental appliances can be coated, their substrate must be pre-treated by pre-treating the surface. The orthodontic and/or dental appliances are moved in a container, preferably in a drum, at the centre of which a spray mechanism is disposed, by means of which the orthodontic and/or dental appliances are briefly sprayed and kept moving by means of an air flow which is generated in the container or introduced into it, thereby drying their surface. After a short drying time, the spray mechanism then emits a coating formulation again whilst the orthodontic and/or dental appliances continue to be moved so that the surface is dried or fully dried and hardened. The temperature in the container is 20° C. to 250° C., and the heat may be generated directly in the container or alternatively introduced in the form of warm air. The surface of the dental and/or orthodontic appliances is preferably dried and hardened for a period of from 10 min to 120 min.

The coating formulation contains at least one solvent, such as ethanol, propanol, butanol or mixtures thereof, which evaporates during the coating process and is no longer or barely detectable, optionally a silicon compound such as glycidyloxypropyltrimethoxy silane, titanium dioxide and/ or titanium nitride as well as silver or a silver compound.

A coating which contains silver ions will suppress the spread of bacteria populations.

The hydrophobic and oleophobic surface properties not only prevent plaque deposits but also prevent discoloration of the surface of the orthodontic and/or dental appliances. The surface of the orthodontic and/or dental appliance therefore exhibits good self-cleaning properties. The hydrophobic properties of the orthodontic and/or dental appliances also makes them much easier to clean. Particularly in the case of such small appliances based on microstructures with the smallest of protruding parts, pieces of food very easily become lodged in various pockets and are very difficult to access with a mechanical device such as a tooth brush. Due to the hydrophobic or oleophobic coating, pieces of food do not become lodged at all because they can already be removed by rinsing the oral cavity.

The substrate and coating are chemically bonded to one another, preferably by a covalent bond. Ultra-thin coatings can be produced. These ultra-thin coatings may have elastic properties comparable with stainless steel.

In addition to high resistance, the surface of the orthodontic and/or dental appliances with a coating proposed by the invention have a high resistance to scratching.

The anti-microbial properties of the coating of the orthodontic and/or dental appliances proposed by the invention were documented in various tests. The coating proposed by the invention is active against Escherichia coli, Campylobacter, Listeria, Salmonella, Pseudomonas, Aspergillus niger, Pleurococcus, Rhodotorula, etc.. The anti-microbial effect of silver works due to silver ions which are able to destroy the surface or membrane of micro-organisms and penetrate them, thereby denaturing both proteins and the nucleic acids of the micro-organism.

The coating formulation may be made up of 10% to 15% ethanol, 8% to 10% 2-propanol, 25% to 30% 1-methoxy-2-propanol, 25% to 30% 2-butanol, 7% to 10% 1-pentanol, less than 5% titanium dioxide and less than 4% silver chloride.

In an alternative embodiment, the coating formulation proposed by the invention may be based on the following composition: 20 to 25% glycidyloxypropyltrimethoxy silane, 1 to 5% methoxypropyl-2-acetate, 3 to 5% solvent naphtha, 50 to 60% n-butyl acetate, 1 to 5% titanium dioxide and 1 to 4% silver chloride. The coating formulation proposed by the invention is naturally not restricted to the compositions given as examples above.

When the coating formulation is applied to the orthodontic and/or dental appliances, the solvents of the coating formulation in particular evaporate. The composition on the orthodontic and/or dental appliance is therefore different from the composition of the coating formulation. In any event, the coating on the orthodontic and/or dental appliance contains at least titanium dioxide and/or titanium nitride and optionally silver ions. If silver chloride is introduced into the coating formulation, the coating of the orthodontic and/or dental appliance will also contain silver ions.

The coating on the orthodontic and/or dental appliance is not porous, which thus imparts particularly good cleaning properties to the orthodontic appliances proposed by the invention.

The coating formulation proposed by the invention may also be applied to tools used for orthodontic work and in the field of dentistry.

The embodiments described as examples represent possible variants of the coating applied to an orthodontic and/or dental appliance, and it should be pointed out at this stage that the in- vention is not specifically limited to the variants specifically described, and instead the individual variants may be used in different combinations with one another and these possible variations lie within the reach of the person skilled in this technical field given the disclosed technical teaching. Accordingly, all conceivable variants which can be obtained by combining individual details of the variants described and illustrated are possible and fall within the scope of the invention.

The objective underlying the independent inventive solutions may be found in the description.

1. Orthodontic and/or dental appliance with at least one substrate, at least certain regions of which are provided with a coating, wherein the coating contains titanium dioxide and/or titanium nitride.

2. Orthodontic and/or dental appliance as claimed in claim 1, wherein the quantity of titanium dioxide and/or titanium nitride is selected from a range with a lower limit of 20% and an upper limit of 95%.

3. Orthodontic and/or dental appliance as claimed in claim 1, wherein titanium dioxide is present in the rutile modification.

4. Orthodontic and/or dental appliance as claimed in claim 1, wherein the coating contains silver or at least one silver compound.

5. Orthodontic and/or dental appliance as claimed in claim 4, wherein the quantity of silver or the at least one silver compound is selected from a range with a lower limit of 0.5% and an upper limit of 25%.

6. Orthodontic and/or dental appliance as claimed in claim 4, wherein the at least one silver compound is selected from a group comprising silver chloride, silver acetate, silver carbonate or mixtures thereof.

7. Orthodontic and/or dental appliance as claimed in claim 1, wherein the coating contains silicon dioxide.

8. Orthodontic and/or dental appliance as claimed in claim 1, wherein the coating contains dye particles.

9. Orthodontic and/or dental appliance as claimed in claim 1, wherein the coating is at least partially hydrophobic and oleophobic.

10. Orthodontic and/or dental appliance as claimed in claim 1, wherein the coating has a thickness selected from a range with a lower limit of 100 nm and an upper limit of 100 μm.

11. Orthodontic and/or dental appliance as claimed in claim 1, wherein the substrate is of metal such as stainless steel, plastic such as polycarbonate, or ceramic material such as monocrystalline or polycrystalline aluminum oxide.

12. Use of the orthodontic and/or dental appliance as claimed in claim 1 in jaw orthopedics as a bracket, archwire, bands, buccal tubes, implant, pint, braces, tooth clip.

13. Use of the orthodontic and/or dental appliance as claimed in claim 1 in dentistry as a replacement tooth, prosthesis, crown, anchor, bridge.

14. Orthodontic system comprising a bracket with a cut-out for accommodating an archwire and an archwire, wherein a coating containing titanium oxide and/or titanium nitride and optionally silver ions is disposed at least in the cut-out.

15. Coating formulation for coating an orthodontic and/or dental appliance as claimed in claim 1 or for coating tools which can be used in the field of dentistry or orthodontics containing at least one solvent selected from a group comprising ethanol, propanol, butanol, optionally a silicon compound selected from a group comprising glycidyloxypropyltrimethoxy silane, titanium dioxide and/or titanium nitride and optionally silver or a silver compound.

16. Method of coating at least certain regions of orthodontic and/or dental appliances with a substrate, whereby the coating is applied to at least certain regions of the substrate in a container by means of a spray mechanism, comprising the steps, (i) spraying the orthodontic and/or dental appliances moved in the container at least once with a coating formulation and (ii) drying and hardening the surface of the sprayed orthodontic and/or dental appliances.

17. Method as claimed in claim 16, wherein heated air is introduced into the container for drying and hardening purposes.

18. Method as claimed in claim 16, wherein the temperature in the container is selected from a range with a lower limit of 20° C. and an upper limit of 250° C.

19. Method as claimed in claim 16, wherein the coating is applied using a coating formulation containing at least one solvent selected from a group comprising ethanol, propanol, butanol, optionally a silicon compound selected from a group comprising glycidyloxypropyltrimethoxy silane, titanium dioxide and/or titanium nitride and optionally silver or a silver compound.
